(19) United States
(12) Patent Application Publication
(10) Pub. No.: US 2006/0136870 A1
(43) Pub. Date: Jun. 22, 2006

(54) Visual user interface for creating multimodal applications

(75) Inventors: Leslie Robert Wilson, Boca Raton, FL (US); Gary Joseph Pietrocarlo, Deerfield Beach, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/021,445

(22) Filed: Dec. 22, 2004

(51) Int. Cl. G06F 9/44

(52) U.S. Cl. 717/109

(57) ABSTRACT

A method to facilitate programming of multimodal access in an integrated development environment (IDE). The method can include receiving at least one user input in a view to create a link between a GUI component and a voice component, and correlating the link to a circumstance under which a voice handler is activated. Multimodal markup code that corresponds to the link can be automatically generated.

### BACKGROUND

1. Field of the Invention

The present invention relates to a user interface for software development and, more particularly, to an application integrated development environment.

2. Description of the Related Art

The processing power of modern electronic devices continues to increase while such devices are becoming ever smaller. For instance, handheld devices that easily fit into one's pocket, such as cell phones and personal digital assistants (PDAs), now handle a wide variety of computing and communication tasks. The small size of these devices exacerbates the already cumbersome task of entering data, which is typically performed using a stylus or numeric keypad. In response, new devices are now being developed to implement multimodal access, which makes user interactions with electronic devices much more convenient.

Multimodal access is the ability to combine multiple input/output modes in the same user session. Typical multimodal access input methods include the use of speech recognition, a keypad/keyboard, a touch screen, and/or a stylus. For example, in a Web browser on a PDA, one can select items by tapping a touchscreen or by providing spoken input. Similarly, one can use voice or a stylus to enter information into a field. With multimodal technology, information presented on the device can be both displayed and spoken.

While multimodal access adds value to small mobile devices, mobility and wireless connectivity are also moving computing itself into new physical environments. In the past, checking one's e-mail or accessing the Internet meant sitting down at a desktop or laptop computer and dialing into an Internet service provider using a modem. Now, such tasks can be performed wirelessly from a myriad of locations which previously lacked Internet accessibility. For example, one now can access the Internet from a bleacher in a football stadium, while walking through a mall, or while driving down the interstate. Bringing electronic devices into such environments requires new ways to access them and the ability to switch between different modes of access.

To facilitate implementation of multimodal access, multimodal markup languages which incorporate both visual markup and voice markup have been developed for creating multimodal applications which offer both visual and voice interfaces. One multimodal markup language set forth in part by IBM is called XHTML+Voice, or simply X+V. X+V is an XML based markup language that uses XMLEvents to synchronize extensible hypertext markup language (XHTML), a visual markup, with voice extensible markup language (VoiceXML), a voice markup. XMLEvents is a text based events syntax for XML that is typically hand coded in a text editor or an XML document view of an integrated development environment (IDE).

Another multimodal markup language is the Speech Application Language Tags (SALT) language as set forth by SALT forum. SALT extends existing visual mark-up languages, such as HTML, XHTML, and XML, to implement multimodal access. More particularly, SALT comprises a small set of XML elements that have associated attributes and document object model (DOM) properties, events and methods. The XML elements are typically hand coded in conjunction with a source markup document to generate multimodal markup that applies a speech interface to the source page.

When multimodal markup is hand coded, it is often difficult for a programmer to visualize the relationships between the events syntax, the voice syntax, and the visual syntax. Thus, it would be beneficial to provide multimodal markup programmers with an interface that simplifies coding of multimodal markup.

### SUMMARY OF THE INVENTION

The present invention provides a solution which simplifies coding of multimodal markup. One embodiment of the present invention can include a method to facilitate programming of multimodal access in an integrated development environment (IDE). The method can include receiving at least one user interaction in a view to create a link between a GUI component and a voice component, and correlating the link to a circumstance under which a voice handler is activated. Multimodal markup code that corresponds to the link can be automatically generated.

Another embodiment of the present invention can include an integrated development environment (IDE) that can receive at least one user interaction in a view to create a link between the GUI component and the voice component and correlate the link to a circumstance under which a voice handler is activated. The IDE also can include a code module that automatically generates multimodal markup code that corresponds to the link and the circumstance.

Another embodiment of the present invention can include a machine readable storage being programmed to cause a machine to perform the various steps described herein.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a system that facilitates programming of multimodal access in accordance with an embodiment of the present invention.

FIG. 2 is a pictorial view of an integrated development environment (IDE) “GUI Source” view containing visual markup code which is useful for understanding the present invention.

FIG. 3 is a pictorial view of an IDE “Multimodal Page” view for linking GUI components with voice components in accordance with an embodiment of the present invention.

FIG. 4 is a pictorial view of an IDE “Voice Source” view containing voice markup code which is useful for understanding the present invention.

FIGS. 5A and 5B, taken together, represent a pictorial view of an IDE “Multimodal Source” view containing multimodal markup code which is useful for understanding the present invention.

FIG. 6 is a flow chart illustrating a method of creating links between GUI components and voice components in accordance with an embodiment of the present invention.

### DETAILED DESCRIPTION OF THE INVENTION

The inventive arrangements disclosed herein provide a solution which simplifies coding of multimodal markup. In accordance with the present invention, an architecture is provided that presents to a user visual representations of one or more multimodal components. Examples of multimodal components are graphical user interface (GUI) components and voice components. As used herein, a voice component represents one or more snippets of voice markup that can be integrated with visual markup. The voice component can be markup code in which the snippets are defined, or an icon or other symbol representing the snippets. A GUI component represents a GUI element that can be linked to one or more voice components. As such, a GUI component can be markup code where the GUI element is defined or a rendering of the GUI element. In a further embodiment, the GUI component can be an icon or other symbol representing the GUI element. Examples of GUI components are rendered fields, checkboxes and text strings. However, there are a myriad of other types GUI components known to the skilled artisan and the present invention is not limited in this regard.

User interactions can be received to create links between the GUI components and the voice components and correlate the links to specific circumstances. For example, user inputs can be received and processed to automatically generate voice markup code and event handler code. The event handler code can be used to link the voice markup code to visual markup code correlating to the GUI components. Accordingly, the present invention provides a simple and intuitive means for generating multimodal markup code. Advantageously, this architecture eliminates the need for a multimodal developer to manually write voice markup code when voice enabling GUI components, thus saving the multimodal developer time.

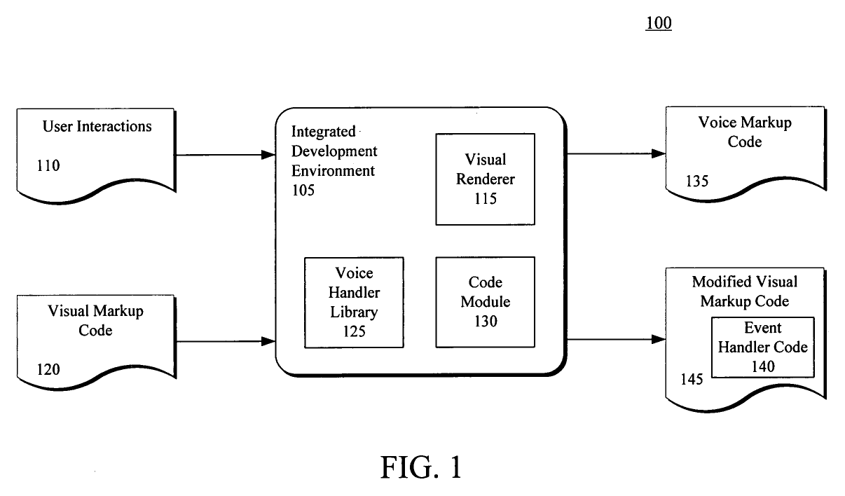

FIG. 1 is a schematic diagram illustrating a system 100 that facilitates programming of multimodal access in accordance with one embodiment of the present invention. The system can include an integrated development environment 105 (IDE) for constructing and testing markup code in response to user interactions 110. The IDE 105 can comprise a visual renderer 115 which renders visual markup code 120, a voice handler library 125 which stores voice components, and a multimodal code generating module 130 (hereinafter “code module”).

The code module 130 can automatically generate voice markup code 135, and add event handler code 140 to the visual markup code 120 to generate modified visual markup code 145. The event handler code 140 can be used to associate the voice markup code 135 with the GUI components. Together the modified visual markup code 145 and the voice markup code 135 can define the multimodal markup code. The multimodal markup code can be contained in a single file (or document), or contained in multiple files. For example, the voice markup code 135 can contain voice components of XHTML+Voice (X+V) markup, and the modified visual markup code 145 can contain visual components of the X+V markup and the event handler code 140. The event handler code 140 can be incorporated into the GUI component definitions within the modified visual markup code 145. For instance, the event handler code 140 can be inserted into an XHTML tag to identify a snippet of VoiceXML that is to be linked to the XHTML tag. The invention is not limited in this regard, however, and the event handler code 140 can be implemented in any other suitable manner.

In one arrangement the code module 130 can comprise a code generation processor and a style sheet generator. Style sheets comprise a plurality of templates, each of which defines a fragment of output as a function of one or more input parameters. The code generation processor can enter markup parameters into a style sheet to generate resultant files/documents as output. The markup parameters can be parsed from data generated from user inputs, such as the user inputs entered to select voice components and establish links between the voice components and respective GUI components. The resultant file generated by the code module 130 can contain multimodal access code which includes the voice markup code 135 and the modified visual markup code 145. Alternatively, various portions of the code can be output to different files/documents. For example, the voice markup code 135 can be output into a document that is distinct from a document containing the modified visual markup code 145. An example of a code generation processor that can be used is an XSLT processor, for example the Xalain XSLT processor or the Saxon XSLT processor.

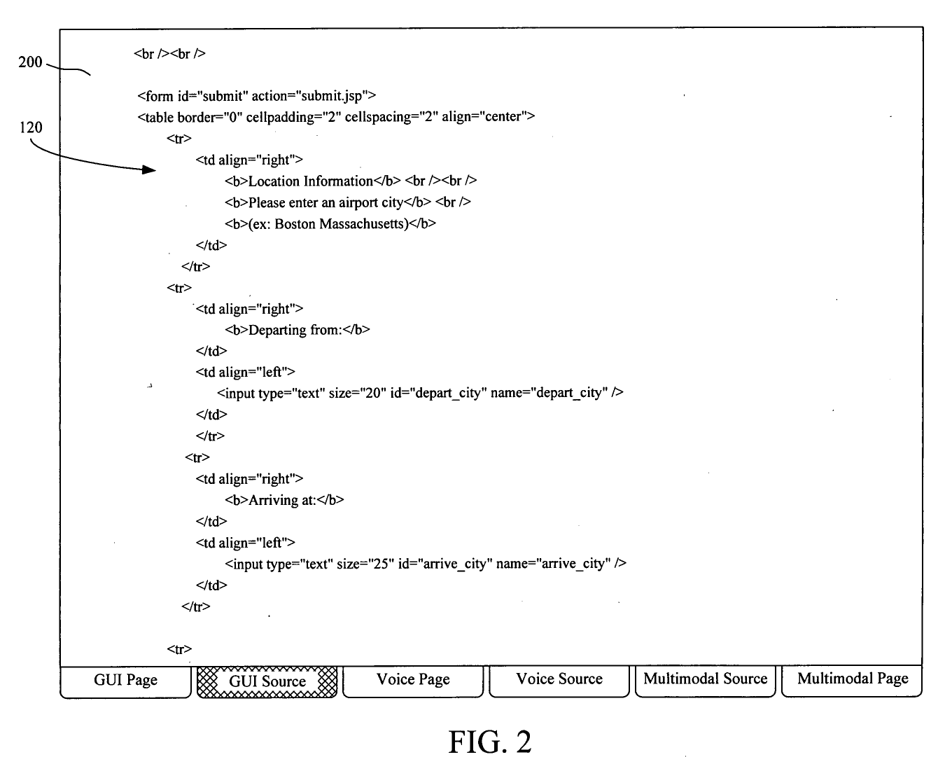

FIG. 2 is a pictorial view of an IDE “GUI Source” view 200 containing the visual markup code 120 which is useful for understanding the present invention. “GUI Source” view 200 can present a text editor which is suitable for entering and editing the visual markup code 120. For example, the IDE text editor can be a text editor optimized for programming in XHTML. Nonetheless, the invention is not limited to XHTML and any other suitable text editor can be used. A user can enter the visual markup code 120 into the “GUI Source” view 200 to serve as a basis for generating multimodal markup code. A “GUI Page” (not shown) can be used to render the visual markup code 120 for testing and troubleshooting purposes.

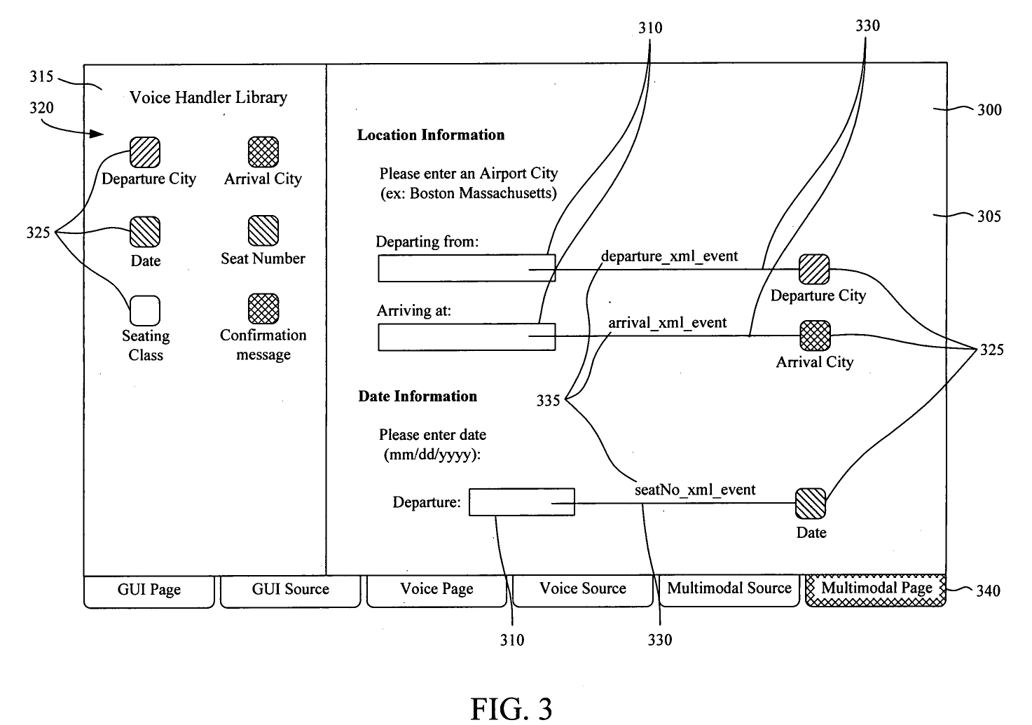

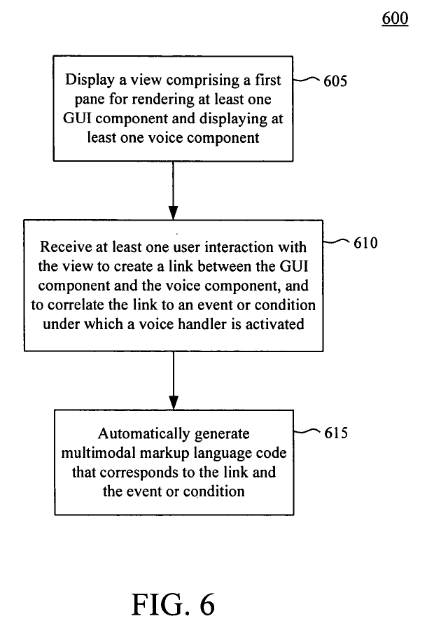

FIG. 6 is a flow chart illustrating a method 600 in which a user interface can be used to create links between GUI components and voice components in accordance with an embodiment of the present invention. FIG. 3 is a pictorial diagram of an IDE “Multimodal Page” view 300 that can be used for implementing the method 600. Making reference both to FIG. 6 and to FIG. 3, the method 600 can begin at step 605 by displaying the “Multimodal Page” view 300. The “Multimodal Page” view 300 can be selected using a “Multimodal Page” tab 340, but the invention is not so limited as any suitable means for receiving a user interaction to navigate between views is within the intended scope of the present invention. For instance, rather than tabs, navigation arrows or menus can be used to select different views.

The “Multimodal Page” view 300 can include a plurality of panes. For instance, the “Multimodal Page” view 300 can include a first pane 305 for rendering GUI components 310 defined in the visual markup code 120, and for receiving user interactions to link GUI components 310 with voice components 325. A second pane 315 can be provided in the “Multimodal Page” view 300 to present a voice handler library 320 to the user. The voice handler library 320 can include one or more previously created voice components 325 (sometimes referred to as artifacts). The voice components 325 can be represented by icons, as shown, or in any other suitable manner. For instance, the voice components 325 can be identified by a text label.

Proceeding to step 610, a user interaction can be received to create a link between at least one of the GUI components 310 and a voice component, and to correlate the link to a circumstance under which the voice handler is activated. For example, the user can select one or more voice components 325 from the second pane 315 and place the voice components 325 in the first pane 305. The user also can create links 330 between the voice components 325 and the GUI components 310. The links 330 can be created by receiving user inputs via a mouse, stylus, touch screen, keyboard, or any other suitable input device. As defined herein, a circumstance can any identifiable event, condition, or state. Examples of circumstances can be a GUI component receiving focus, an activation of a particular view, a loading of a page, a selection of an icon, a time of day, or any human or non-human interactions.

The user also can enter identifiers 335 that specify circumstances that trigger voice handler operations. For instance, each identifier 335 can specify a circumstance associated with a particular GUI component 310 that triggers the voice handler to process a voice component 325 that is linked to the GUI component 310. As shown, the links 330 are depicted as lines extending between the GUI components 310 and the respective voice components 325. However, other methods of identifying links between the GUI components 310 and the voice components 325 can be used and the invention is not limited in this regard. For instance, GUI components 310 and corresponding voice components 325 can be displayed in the same color, displayed with corresponding numerical identifiers, or shown as being linked in any other suitable fashion.

At step 615, the code module can automatically generate multimodal markup code that corresponds to the links 330 and the circumstances specified by the identifiers 335. For example, when the user selects voice components 325 by placing the voice components 325 in the first pane 305 or by linking the voice components 325 to the GUI components 310, the IDE can pass parameters correlating to the user actions to the code module. The code module can automatically incorporate the input parameters into style sheets to generate correlating voice markup code, event handler code and header information. For example, the voice markup code can be generated from parameters associated with a selected GUI component and a voice component to which the GUI component is linked. In addition to GUI component and voice component parameters, parameters associated with the specified circumstances indicated by the identifiers 335 can be used to generate the event handler code. The code module then can automatically integrate the generated voice markup code, event handler code and header information with the visual markup code 120 to generate the multimodal markup code.

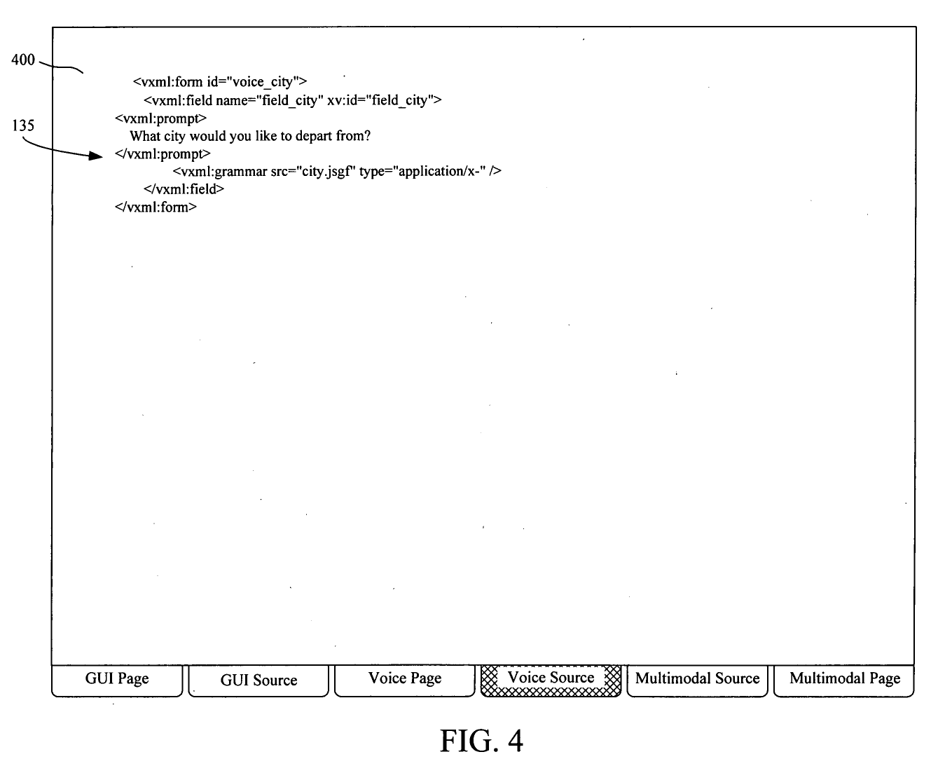

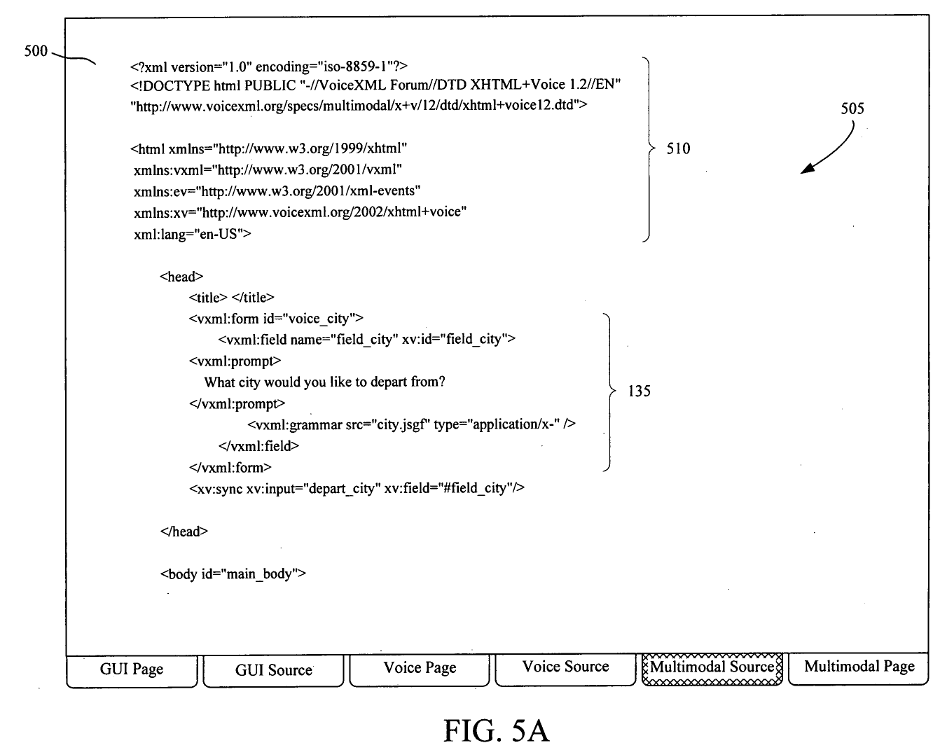

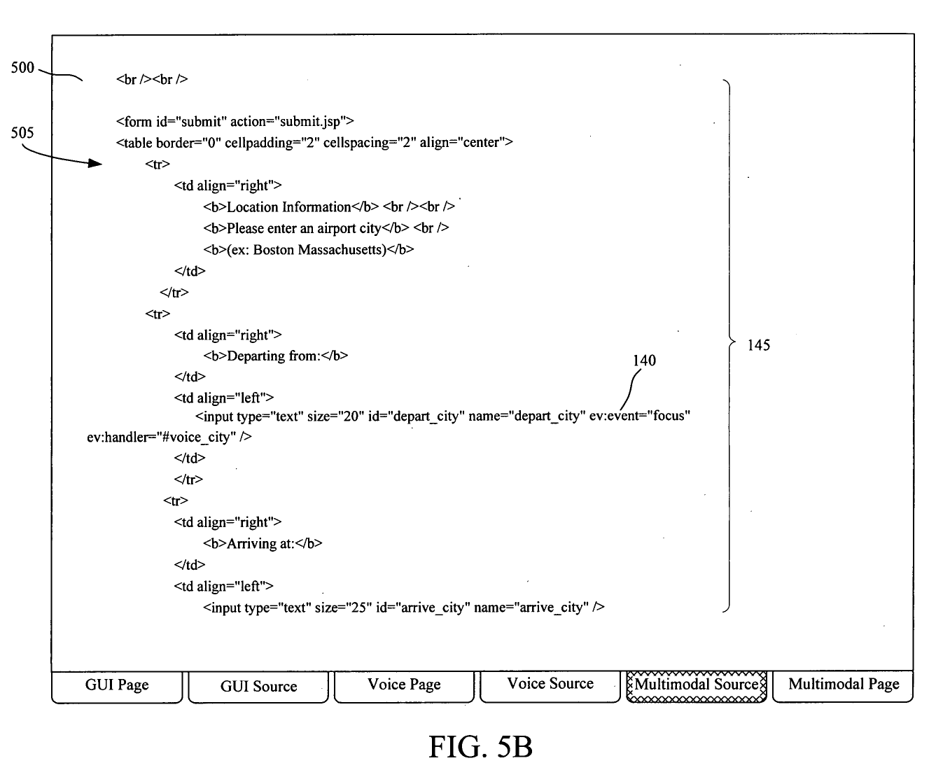

Referring to FIG. 4, a “Voice Source” view 400 can be provided in the IDE to display the voice markup code 135. Further, a “Multimodal Source” view 500 can be displayed, as shown in FIGS. 5A and 5B, to show multimodal markup code 505 which results from the integration of the voice markup code 135, header information 510 and event handler code 140 within the modified visual markup code 145. Notably, the code module can automatically update the multimodal markup code 505 as the user makes edits in the Multimodal Page. For instance, if a user removes a voice component 325 from the first pane 305, the code module can remove corresponding voice markup code 135 from the “Voice Source” view 400 and from the multimodal markup code 505. Additionally, corresponding event handler code 140 also can be removed from the multimodal markup code 505.

Moreover, edits to the visual markup code 120 also can be reflected in the rendering of the GUI components 310 shown in the “Multimodal Page” view 300. For example, the GUI components 310 can be rendered with the latest version of the visual markup code 120 each time the user selects the “Multimodal Page” tab 340 to display the “Multimodal Page” view 300. Likewise, the second pane 315 can be updated to reflect any deletions or additions of voice components 325 to the voice handler library 320.

At this point it should be noted that the invention is not limited to any particular multimodal access language, but instead can be used to automatically generate multimodal markup code using any suitable language. For example, the methods and systems described herein can be used to generate multimodal markup code using the Speech Application Language Tags (SALT) language.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software, or software application, in the present context, means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method to facilitate programming of multimodal access in an integrated development environment (IDE), comprising:
receiving at least one user interaction with a view to create a link between at least one graphical user interface (GUI) component and at least a first voice component and correlate said link to at least one circumstance under which a voice handler is activated; and
automatically generating multimodal markup code that corresponds to said link and said at least one circumstance.

2. The method according to claim 1, further comprising displaying in said view at least one multimodal component selected from the group consisting of said GUI component and said first voice component.

3. The method according to claim 2, further comprising displaying in said view a voice handler library comprising a plurality of selectable voice components.

4. The method according to claim 3, further comprising displaying said GUI component and said voice component in a pane in said view, wherein said first voice component is selected from said voice handler library.

5. The method according to claim 1, wherein said step of receiving at least one user interaction comprises receiving at least one identifier that identifies said circumstance.

6. The method according to claim 1, wherein said step of receiving at least one user interaction comprises:
receiving a cursor selection that defines said link between said GUI component and said first voice component; and
receiving at least one identifier that identifies said circumstance.

7. The method according to claim 1, further comprising rendering said GUI component in a pane in said view in accordance with visual markup code.

8. The method according to claim 1, further comprising selectively displaying said view from among a plurality of views in said IDE in response to a said at least one interaction.

9. A machine readable storage, having stored thereon a computer program having a plurality of code sections executable by a machine for causing the machine to perform the steps of:
receiving at least one user interaction with a view to create a link between at least one graphical user interface (GUI) component and at least a first voice component and correlate said link to at least one circumstance under which a voice handler is activated; and
automatically generating multimodal markup code that corresponds to said link and said at least one circumstance.

10. The machine readable storage of claim 9, further causing the machine to perform the step of displaying in said view at least one multimodal component selected from the group consisting of said GUI component and said first voice component.

11. The machine readable storage of claim 10, further causing the machine to perform the step of displaying in said view a voice handler library comprising a plurality of selectable voice components.

12. The machine readable storage of claim 11, further causing the machine to perform the step of displaying said GUI component and said voice component in a pane in said view, wherein said first voice component is selected from said voice handler library.

13. The machine readable storage of claim 9, wherein said step of receiving at least one user interaction comprises receiving at least one identifier that identifies said circumstance.

14. The machine readable storage of claim 9, wherein said step of receiving at least one user interaction comprises:
receiving a cursor selection that defines said link between said GUI component and said first voice component; and
receiving at least one identifier that identifies said circumstance.

15. The machine readable storage of claim 9, further causing the machine to perform the step of rendering said GUI component in a pane in said view in accordance with visual markup code.

16. The machine readable storage of claim 9, further causing the machine to perform the step of selectively displaying said view from among a plurality of views in said IDE in response to said at least one user interaction.

17. An integrated development environment (IDE), comprising:
an IDE that receives at least one user interaction in a view to create a link between at least one GUI component and a first voice component and correlate said link to at least one circumstance under which a voice handler is activated; and
a code module that automatically generates multimodal markup code that corresponds to said link and said at least one circumstance.

18. The IDE of claim 17, wherein at least one multimodal component is displayed in said view, said at least one multimodal component being selected from the group consisting of said GUI component and said first voice component.

19. The IDE of claim 18, wherein a voice handler library comprising a plurality of selectable voice components is displayed in said view.

20. The IDE of claim 17, wherein said at least one user interaction generates at least one identifier that identifies said circumstance.
